(19) United States
(12) Patent Application Publication
(10) Pub. No.: US 2018/0156934 A1
(43) Pub. Date: Jun. 7, 2018

(54) METHODS AND SYSTEMS FOR PROCESSING GEOLOGICAL DATA

(71) Applicant: Senergy Software Ltd., Kingswells, Aberdeen (GB)

(72) Inventor: Hamish Strang, Aberdeen (UK)

(21) Appl. No.: 15/578,822

(22) PCT Filed: Jun. 1, 2016
(86) PCT No.: PCT/GB2016/051599

§ 371 Date: Dec. 1, 2017

(30) Foreign Application Priority Data
Jun. 1, 2015 (GB) 1509448.5

(51) Int. Cl. G01V 1/34; G01V 11/00; G01V 99/00

(52) U.S. Cl. CPC G01V 1/34; G01V 2210/64; G01V 99/005; G01V 11/00

(57) ABSTRACT

Methods and systems for processing geological data includes initially obtaining datasets relating to a plurality of geological zones associated with a region of geological interest. Data from the datasets may be associated with a plurality of intervals. An interval may correspond to one or more identifiable layers of strata at the geological zones and may be associated with a geological event. For each geological zone, a selected data type from each dataset in relation to a particular interval can initially be displayed. A user can then select a modified interval having a different geological event. The methods and systems then can display, for each geological region, a modified selected data type from each data set based on the modified interval.

### REFERENCE TO RELATED APPLICATIONS

This application is a United States National Phase application of PCT Application No. PCT/GB2016/051599 filed on Jun. 1, 2016 which claims priority to United Kingdom Application No. 1509448.5 filed on Jun. 1, 2015.

### TECHNICAL FIELD

Some described examples relate to methods and systems for processing data, particularly data relating to geological zones (e.g., wellbores and near wellbore formations) associated with regions of geological interest (e.g., regions including hydrocarbon-bearing formations).

### BACKGROUND

Significant innovation and technology development has occurred in recent years in relation to processing, analysing and interpreting data from geological regions of interest. Generally, such data has been accumulated in relation to hydrocarbon exploration and production, but in other cases such data may also relate to hydrological exploration/production or mineral mining, or the like.

The cost of such exploration, etc., is significant and errors in geological assessment can result in significant time delays in relation to particular projects, or indeed abandonment of projects altogether—in either case bringing with it significant commercial loses. This is particularly true of hydrocarbon exploration, and more so when assessing mature or unconventional fields.

As such, more sophisticated measurement and analytical tools are being used in order to assess and measure the geological regions in advance of complex drilling operations. As a consequent, the volume of data collected and available for use by geologist, petroleum engineers, or the like, is significant and can be difficult to comprehend in an efficient manner that would otherwise allow for expedient and accurate assessment of the data. The ability to view and browse significantly large datasets including different data types, in an informed manner, can assist in making critical assessments that are paramount to the success of exploration projects.

This background serves only to set a scene to allow a skilled reader to better appreciate the following description. Therefore, none of the above discussion should necessarily be taken as an acknowledgement that that discussion is part of the state of the art or is common general knowledge. One or more described aspects/embodiments of the invention may or may not address one or more of the background issues.

### SUMMARY

Some examples describe systems and methods for processing data relating to geological zones (e.g., wellbores, and near wellbore formations), which may be associated with regions of geological interest (e.g., regions including hydrocarbon-bearing formations).

Such described methods and systems may permit ease of comprehension of data in an efficient manner, and/or may provide the ability to view and browse significantly large data/datasets in an informed way. In either case, this may assist with expedient and accurate assessment of data, thus allowing for critical assessments to be made quickly and easily that may be paramount to the success of exploration projects, or the like.

In some examples, there are provided methods including obtaining datasets relating to a one or more, or indeed a plurality, of geological zones associated with a region of geological interest. That region of geological interest may include, or be expected to include, commercially significant hydrocarbon-bearing formations, for example, or indeed water, minerals or the like.

The geological zones may include wellbores, or the like. In other similar words, each zone may be defined by a zone having a particular depth and direction within the region of geological interest. The wellbores may include exploration wells, existing production wells, or the like. Of course, when considering geological zones as wellbores, this may also include surrounding regions, such as the near wellbore formation, and the like.

The method may include obtaining the datasets from existing data stores or databases. Some or all of the data forming those datasets may be have been compiled from previous data gathering processes, or indeed some or all of the data associated with the dataset may be obtained directly from such gathering processes. Such data gathering processes may include, seismic testing or logging analysis, including logging-while-drilling, etc. Each dataset may therefore contain data relating to lithography, environmental conditions, or the like, for a particular geological zone (e.g., wellbore and near wellbore formation). In any case, the datasets may be obtained and stored locally, or may be accessible using a network connection (e.g., via an access point).

Each dataset may include a plurality of different data types (e.g., common data types between each particular geological zone). In other similar words, each dataset may include a first data type including data relating to a first type data collection at the zone (e.g., lithographic measurements), as well as a second data type including data relating to a second type of data collection the zone (e.g., environmental conditions), as well as a third data type, and so on.

The method may include associating data from each of the datasets with a plurality of intervals or “geological units” for each geological zone. Each interval may correspond to one or more identifiable layers of strata at the geological zones. For example, in some cases, each interval may include a single identifiable stratum, but in other examples, an interval may include multiple identifiable layers of strata, which may be consecutive layers of strata.

In either case, each interval may be considered to relate to a particular geological event (e.g., age). That geological event may be classified in—or form part of a—geological dictionary. Examples of such include stratigraphic schemes (e.g., naming systems used to describe intervals, or portions of intervals, in terms of events/timescale).

Intervals may have a particular geological event resolution. That is to say, in some cases, the interval may include one or more strata, with each stratum having a top event considered to be the youngest and a bottom event considered to be oldest. The difference between the top event and the bottom event for each stratum may be used to define a resolution of the stratum, and so the resolution of the overall interval. In some cases, for example when the event is defined directly in terms of time, the difference between the top event and the bottom event for each stratum may be used to define a resolution of the stratum.

The method may include displaying, for each geological zone, a selected data type from each dataset in relation to a particular interval (e.g., a selected or predefined interval). In other similar words, the method may include displaying for each geological zone, data that is from a common data type across each dataset, and that data is for an interval that is common to each of the geological zones. The particular data type that is selected may be user selected. In other similar words, a user may choose which particular data type within the datasets is to be displayed. Similarly, a user may choose the particular interval.

The method may include displaying the selected data type for a particular interval for each geological zone on a virtual map. That virtual map may represent some or all of the region of geological interest. That virtual map may be presented to a user at a user interface, such as a computer display, or portable device display (e.g., tablet display). The virtual map may provide a simplified 2D representation of the region of geological interest, or indeed the virtual map may provide a 3D representation of the region of geological interest.

Data associated with the selected data type may be displayed as icon representations of values, compositions, or the like, for each geological zone. Data may be displayed as bubbles, or analytical sticks, or the like.

In some examples, where a dataset relating to a particular geological zone does not contain data relating to the particular interval, then the method may include displaying inferred data for that particular zone and interval (e.g., absent interval).

The inferred data may be approximation based on geological zones in proximity to that zone. The inferred data may be data associated with corresponding intervals associated with that geological zone. The data may be interpolated from similar data from different intervals associated with that particular zone.

Subsequently, the method may include selecting a modified interval relating to a different geological event (e.g., age), and displaying, for each geological region, a modified selected data type from each dataset based on the modified interval.

The different geological event may be a different classification of event. That different classification of event may be an event that is consecutive (e.g., time consecutive) with the previous event (e.g., at a particular resolution). In other similar words, the different event may include the next younger or older classification of geological event of the interval (or strata within the interval). The different geological event may additionally or alternatively have a different geological event resolution (e.g., age resolution). That is to say that, in terms of timescales, the geological event of the modified interval may be contained—wholly or partially—within the previous geological event, or may include and extend beyond the previous geological event.

The method may include selecting, via an icon representation at a user interface, the modified interval and/or selected data type.

In some examples, there is described a method for processing data—and in particular large volumes of data by:

obtaining datasets relating to a plurality of geological zones associated with a region of geological interest;

associating data from the datasets with a plurality of intervals, each interval corresponding to one or more identifiable layers of strata at the geological zones, and each interval having a geological age;

displaying, for each geological zone, a selected data type from each dataset in relation to a particular interval; and then

selecting a modified interval having a different geological age, and displaying, for each geological region, a modified selected data type from each data set based on the modified interval.

In some examples, there is described a method for processing data—and in particular large volumes of data by:

obtaining datasets relating to a plurality of geological zones associated with a region of geological interest;

associating data from the datasets with a plurality of intervals, each interval corresponding to one or more identifiable layers of strata at the geological zones, and each interval associated with geological event(s);

displaying, for each geological zone, a selected data type from each dataset in relation to a particular interval; and then

selecting a modified interval having a different geological event, and displaying, for each geological region, a modified selected data type from each data set based on the modified interval.

In some examples, there is described a method for processing data, including;

obtaining datasets relating to a plurality of geological zones associated with a region of geological interest;

associating data from the datasets with a plurality of intervals, each interval corresponding to one or more identifiable layers of strata at the geological zones, and each interval having a geological age;

displaying, for some or all geological zones, a selected data type from each dataset in relation to a particular interval; and

in the absence of data of a selected data type for one or more geological zones, then displaying inferred data for that or each zone.

In some examples, there is described a method for processing data, including:

obtaining datasets relating to a plurality of geological zones associated with a region of geological interest;

associating data from the datasets with a plurality of intervals, each interval corresponding to one or more identifiable layers of strata at the geological zones, and each interval associated with geological event(s);

displaying, for some or all geological zones, a selected data type from each dataset in relation to a particular interval; and

in the absence of data of a selected data type for one or more geological zones, then displaying inferred data for that or each zone.

In further examples, there are described systems for processing and displaying data. Those systems may be configured to process data relating to geological zones (e.g., wellbores, and near wellbore formations, etc.), which may be associated with regions of geological interest (e.g., regions including hydrocarbon-bearing formations).

Such a system may comprise a user interface, for example including a display. The system may comprise a processor and memory configured in a known operative manner so as to permit processing and displaying of data relating to geological zones at the user interface.

The system may be in communication with one or more databases or datastores, and be configured to obtain datasets including data relating to particular geological zones. Additionally, or alternatively, the system may include databases (e.g., locally at the system) so as to obtain datasets.

Some or all of the data forming those datasets may be have been compiled from previous data gathering processes, or indeed some or all of the data associated with the datasets may be obtainable directly from such gathering processes. The system may be configured to compile data from various different data gathering processes and store remotely or locally at the system.

Such data gathering processes may include, seismic testing or logging analysis, including logging-while-drilling, etc. Each dataset may therefore contain data relating to lithography, environmental conditions, or the like for a particular geological zone (e.g., wellbore and near wellbore formation). In any case, the system may be configured such that the datasets are obtainable and stored locally, or may be accessible using a network connection (e.g., via an access point).

Each dataset may include a plurality of different data types (e.g., common data types for each particular geological zone). In other similar words, each dataset may include a first data type including data relating to a first type data collection at the zone (e.g., lithographic measurements), as well as a second data type including data relating to a second type of data collection the zone (e.g., environmental conditions), as well as a third data type, and so on.

The system may be configured to display particular data on a virtual map (e.g., a selected data type for each geological zone on a virtual map). That virtual map may represent some or all of the region of geological interest. The system may be configured to present to a user, the virtual map, at the user interface. The virtual map may provide a simplified 2D representation of the region of geological interest, or indeed the virtual map may provide a 3D representation of the region of geological interest.

The system may be configured to display, particular data, as icon representations of values, compositions, or the like, for each geological zone. Data may be displayed as bubbles, or analytical sticks or the like.

The system may be configured to permit selection, via the user interface (e.g., using an icon representation at a user interface), modified intervals and/or selected data type.

In some examples, there is described a system method for processing data—and in particular large volumes of data, the system being configured to:

obtain datasets relating to a plurality of geological zones associated with a region of geological interest;

associate data from the datasets with a plurality of intervals, each interval corresponding to one or more identifiable layers of strata at the geological zones, and each interval being associated with a geological event;

display, at a user interface, for each geological zone, a selected data type from each dataset in relation to a particular interval; and then

permit selection of a modified interval having a different geological event, and display, for each geological region, a modified selected data type from each data set based on the modified interval.

In some examples, there is described a system for processing data configured to

obtain datasets relating to a plurality of geological zones associated with a region of geological interest;

associate data from the datasets with a plurality of intervals, each interval corresponding to one or more identifiable layers of strata at the geological zones, and each interval being associated with a geological event;

display, at a user interface, for some or all geological zones, a selected data type from each dataset in relation to a particular interval; and

in the absence of data of a selected data type for one or more geological zones, then display inferred data for that or each zone.

In some examples, there is provided a computer program product or computer file configured to at least partially (or fully) implement the system and methods as described above. In some examples, there is also provided a carrier medium including or encoding the computer program product or computer file, in some examples in a non-transitory manner In some examples, there is also provided processing apparatus when programmed with the computer program product described. Some of the above examples may implement certain functionality by means of software, but also that functionality could equally be implemented solely in hardware (for example by means of one or more ASICs (application specific integrated circuit) or Field Programmable Gate Arrays (FPGAs)), or indeed by a mix of hardware and software (e.g., firmware). As such, the scope of the present invention should not be interpreted as being limited only to being implemented in software.

Aspects described may include one or more examples, embodiments or features in isolation or in various combinations whether or not specifically stated (including claimed) in that combination or in isolation. It will be appreciated that one or more embodiments/examples may be useful when processing geological data, particular large volumes thereof. The above summary is intended to be merely exemplary and non-limiting.

### BRIEF DESCRIPTION OF THE FIGURES

A description is now given, by way of example only, with reference to the accompanying drawings, in which:

FIG. 1 shows a simplified representation system;

FIG. 2 shows an example of a region of geological interest having geological zones

FIG. 3 shows a stratigraphic scheme;

FIGS. 4 and 4b show an example of a 2D virtual map;

FIGS. 5a and 5b show exemplary interfaces;

FIGS. 6a-6c show examples of 2D virtual map; and

FIG. 7 shows an example if a 3D virtual map.

### DESCRIPTION OF SPECIFIC EMBODIMENTS

While some of the following examples are described with reference specifically to systems and methods for processing data relating to hydrocarbon formations, it will nevertheless be appreciated that certain aspects of the described examples may equally be used beyond the oil and gas industry, for example within industries in which it is important—or helpful—to accurately and/or quickly and/or cost effectively determine properties of geological regions of interest. A skilled person would be able to implement those further embodiments accordingly.

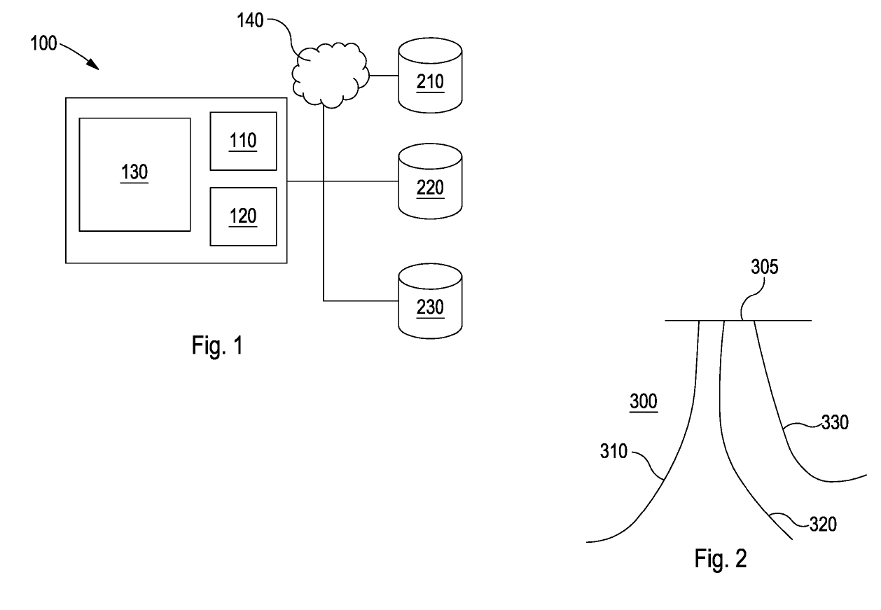

FIG. 1 shows a simplified representation of a system 100 for processing and displaying data, and in particular geological data as will be described. In particular, the system 100 and described methods permit geologists, petroleum engineers, or the like, better to comprehend significant volumes of data in an efficient manner, and/or provide the ability to view and browse significantly large data/datasets in an informed way. In either case, this can assist with expedient and accurate assessment of data, thus allow for critical assessments to be made quickly and easily that may be paramount to the success of exploration projects.

Here, the system 100 includes a processor 110 and memory 120 configured in a known manner, and configured to operatively control a user interface 130. The user interface 130 may include a display, or the like, and may be configured to permit user input or selection (e.g., via a touch screen, keyboard, or the like). By way of an example, the system 100 is further in communication with three data stores or databases 210, 220, 230 (in other examples, more may be provided). In some cases, the system 100 may be in communication with those databases locally (e.g., the databases they are provided/included at the system), and/or otherwise the system may be in communication with the databases 210, 220, 230 over a network connection (as exemplified at 140).

In any event, each of the databases 210, 220, 230 are configured to store datasets relating to one or more particular geological zones associated with a region of geological interest.

FIG. 2 shows a simplified representation of a region of geological interest 300 including—in this example—three geological zones 310, 320, 330 associated with the region 300 (again more may be provided). The region of geological interest 300 may be considered to be a geographic area with the likely commercial potential to produce hydrocarbons, or the like. In other words, the region of geological interest 300 may include, or be expected to include, commercially significant hydrocarbon-bearing formations, for example.

The geological zones 310, 320, 330 may be defined as specific areas or zones within the more expansive region of geological interest 300, and may include wellbores, and the nearby formation (e.g., near wellbore formations), or the like—as is shown here, extending from surface 305 or seabed 305 to the subsurface formation. It will be appreciated that while in many cases, a geological zone 310, 320, 330 is likely to be defined by a wellbore, in some cases that need not be the case. For example, a zone 310, 320, 330 may be defined by any specific region from which geological data has been collected pertaining to the subsurface structure at the region on geological interest 300.

That said, and for the purposes of the following illustrative example, each geological zone 310, 320, 330 here can be considered to be a wellbore region extending through the geological region of interest 300. In the example shown in FIG. 2, the wellbores shown are deviated from vertical, as might be expected in some cases.

Each particular database includes one or more datasets associated with a particular zone. Data forming the datasets stored at the databases 310, 320, 330 may be have been compiled from previous data gathering processes, or indeed some or all of the data associated with the dataset may be obtained directly from such gathering processes. Such data gathering processes might include, seismic testing or logging analysis, including logging-while-drilling, etc. Each of the datasets stored at the database may contain therefore data spanning many different collection methods for each particular geological zone 310, 320, 330 respectively. In some examples, the data may be considered to be “raw” data.

Therefore, each dataset may be considered to include a plurality of different data types associated with a particular zone 310, 320, 330. In other similar words, the dataset stored at the first database 310 includes a first data type including data relating to a first type of data collection (e.g., lithographic measurements), as well as a second data type including data relating to a second type of data collection (e.g., environmental conditions), as well as a third data type, and so on. Examples of data types include data associated with lithography, environmental conditions, structural engineering data, core analysis, thermal data, geochemical data, specific organic carbon data, or the like. Here, the system 100 is configured to organise the datasets and data types such that each dataset contains common data types of data across the zones 310, 320, 330.

As will be appreciated with reference to FIG. 2, each wellbore 310, 320, 330 follows a different trajectory such that at a particular depth or distance from surface 305, the data obtained may be unrelated to the same data obtained at the same or similar depth in a different wellbore. This is further confounded by the fact the layering of strata or any subsurface formation may be irregular and uneven. As such, this may present difficulties in processing and analysing significant volumes of data, without rendering the data completely in 3D space, which would be computationally expensive and time consuming. Further therefore, it can be difficult to expediently and accurately make assessments of data that allow for decision to be made regarding exploration projects.

In this example therefore, the system 100 is further configured to associate data from the datasets according to a stratigraphic scheme 400. Such a scheme can be considered to classify the data from the datasets according to geological age.

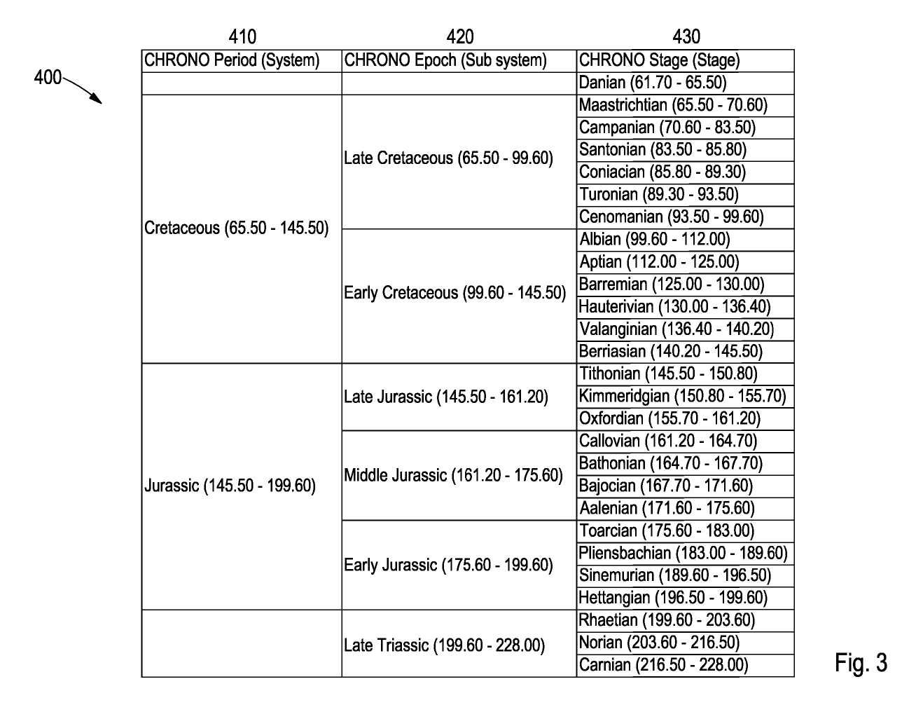

FIG. 3 shows one example of an excerpt of an exemplary stratigraphic scheme 400, or put differently a classification system that can be used to define “intervals” in terms of hierarchy. That hierarchy may be defined in terms of events, whether directly relating to a timescale (e.g., time stratigraphy—as is the example shown here), or indirectly relating to a timescale (e.g., life or parent/child stratigraphy). Of course, when considering “interval” in terms of geological events, then either type of hierarchy may be used. As will be further explained, in this example the system 100 is configured to display data from the datasets based on one or more selected “intervals”. Those intervals can be user selected.

An interval may be considered to one or more identifiable layers of rock formation or strata at the geological zones 310, 320, 330. As will readily be appreciated, due to the manner in which common geological deposition occurs, the older deposited rock formation is likely to be found at greater depths from the surface 305 than younger rock formation. However, across a region of interest 300, a particular interval may be observed at different depths and have different thickness (in the depth direction). In other words, the subsurface formations and strata layers are typically not formed parallel to one another, and generally will not have a common thickness across the formation. Therefore, an interval may be considered to be event-defined layer (e.g., time-defined or time-bound layer) within the region of interest 300, rather than being defined according to location.

In the example shown in FIG. 3, the system 100 is further configured to associate data according to different resolution of hierarchy, and in essence geological events (e.g., age, whether directly or indirectly).

For the purposes of the following example, a time stratigraphic hierarchy has been used (i.e. defining events chronostratigraphically). Here, three levels of resolution have been used 410, 420, 430. Due to the use of different resolutions, data from each dataset may be grouped according to coarse event resolution (e.g., coarse time resolution), such as a general period 410, as well as finer event/time resolutions, such as epoch 420 within the period, or a stage 430 within the epoch (as is shown in FIG. 3).

Any selected intervals therefore may have associated therewith a particular geological event and event resolution (e.g., age and age resolution). That is to say, a selected interval may include one or more strata, with each stratum within that interval having a top event (which in this case would be considered to be the youngest) and a bottom event (which in this case would be considered to be oldest). The difference between the top event and the bottom event for each stratum may be used to define a resolution of the stratum, and so the resolution of the overall interval. In some cases, an interval may include a single identifiable stratum defined by event/time, but of course in other examples, an interval may include multiple identifiable layers of strata, which may be consecutive layers of strata.

In this case, any association of data with the stratigraphic scheme 400 is stored at the respective databases 310, 320, 330, but of course in other examples, that association may be stored at the system 100.

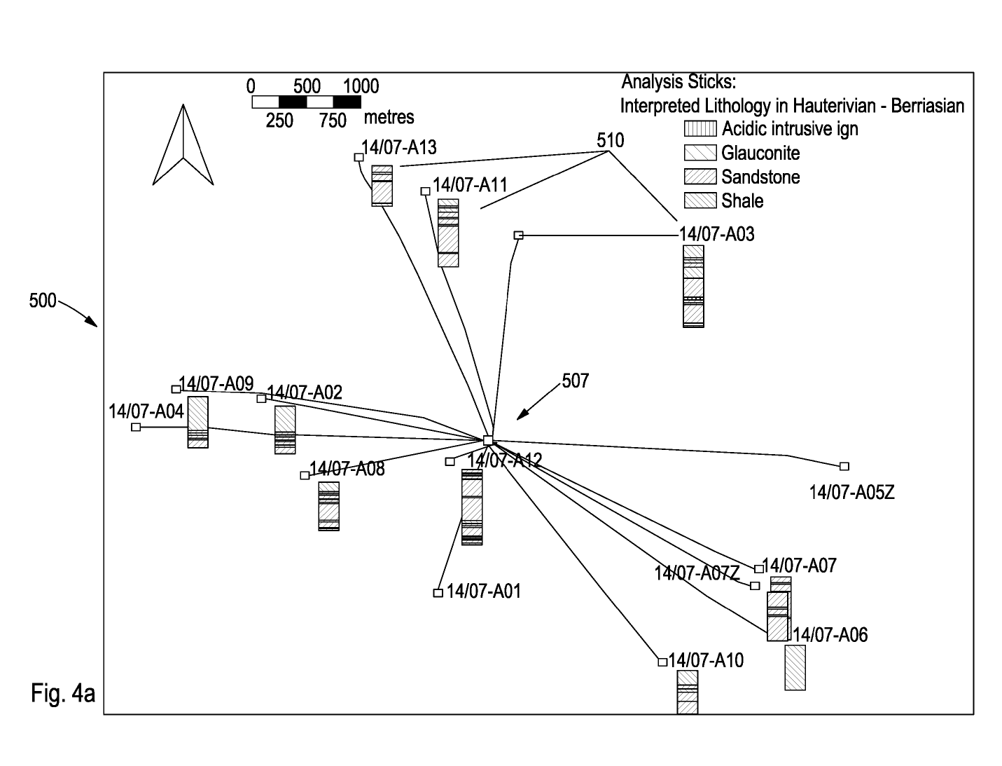

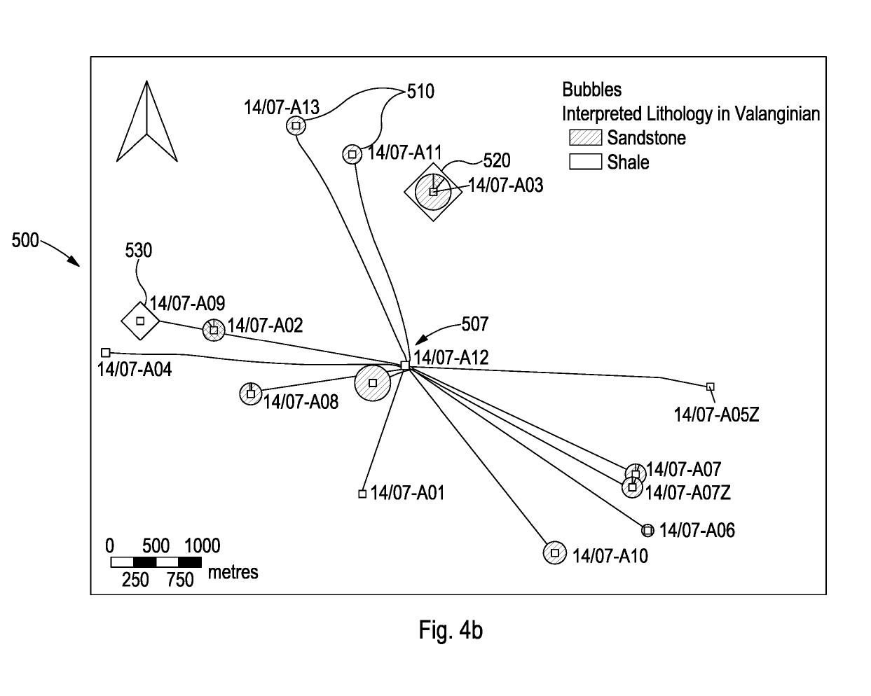

FIG. 4 shows a representation of a virtual map 500, which may be presented to a user at the user interface 130. In this example, the virtual map 500 is a 2D rendering or 2D approximation relating to multiple geological zones 510, and their general spatial relationship relative to one another. The representation may be considered to be viewing the region of geological interest 300 perpendicular to the surface 305. In this example, most of the geological zones (e.g., wellbore) extend from a common region 507 at surface.

Here, the system 100 is configured to display, for each geological zone 510, a selected data type from each dataset. That selected data type may be user selected. For example, at the user interface 130 a user may be able to select which particular data type is of interest within each of the datasets (e.g., lithography, environmental conditions, structural engineering data, core analysis, thermal data, geochemical data, specific organic carbon data, etc.)

In FIG. 4a, lithographic data is shown for each geological zone 510, which displays composition of rock, for example, shale, sandstone, gluaconite, etc. Here, the system 100 is configured to present the data relating only to a particular selected or defined interval. In other similar words, the system 100 is configured to display, for each geological zones 510, data that is from a common data type (e.g., lithographic data) within each dataset, and that data is for an interval that is common to each of the geological zones. It will be appreciated that the data may be sourced from different depths within the region of interest 300, but nevertheless presented to the user in a 2D manner, without the need to render the data in a 3D space.

Here, the data associated with the selected data type is displayed as icon representations of values, compositions, or the like, for each geological zone 510. In particular the different composition and overall depth of the particular interval in question is shown by an analysis stick (in other examples, bubbles may be used, as is shown by way of an example in FIG. 4b).

In some examples, where a dataset 510 relating to a particular geological zone 510 does not contain data relating to the particular selected interval—but it is expected that data should be present—, then the system 100 may be configured to generate and display “inferred” data for that particular zone and interval. Inferred data may be calculated, approximated, or “best guessed” data. In some cases, the inferred data may be an approximation based on geological zones 510 in proximity to that particular zone. However, in this example, the system 100 is configured to interpolate data from similar data from different intervals associated with that particular zone. Those different intervals may be the most immediately positioned in terms of event hierarchy (e.g., time) for which data can be derived. In other words, and with reference to FIG. 3, if the interval in question was the Middle Jurassic epoch and, for one particular zone, no data existed in relation to a selected data type, then data may be inferred by interpolating, or other such regressive analysis, similar data from the Late Jurassic and the Early Jurassic epochs.

In such cases, however, those zones for which the system 100 has inferred data may be shown on the virtual map 500 (e.g., by a marker or the like). FIG. 4b shows an example of the virtual map 500 having a geological zone 520 for which inferred data is present. Here, data relating to the selected data type is shown together with an indicia highlighting that the data is inferred.

It will be appreciated that those regions for where data for an interval may be absent, may be of particular interest to a geologist, as this may represent some form of erosion or fracture or the like. FIG. 4b also shows an example of a geological zone 530 for which no data is present due to an unconformity.

Here, due to the manner in which the data has been classified and stored, the system 100 is further configured to permit selecting of a modified interval relating to a different geological event (e.g., age), and displaying, for each geological region, a modified selected data type from each data set based on the modified interval. In other words, a user can efficiently alter the interval being represented and the system 100 is configured to revise and update the selected datatype for each zone 510 based on the modified interval (e.g., and present the revision simultaneously to a user across a geological region, or the like). The different geological event (e.g., age) may be a different classification (e.g., classification of age). That different classification may be concurrent or consecutive with the previous event. In some examples, the different event may be the next immediate younger or older classification of geological age of the interval (or strata within the interval). The different geological event may additionally or alternatively have a different geological event resolution (e.g., age resolution).

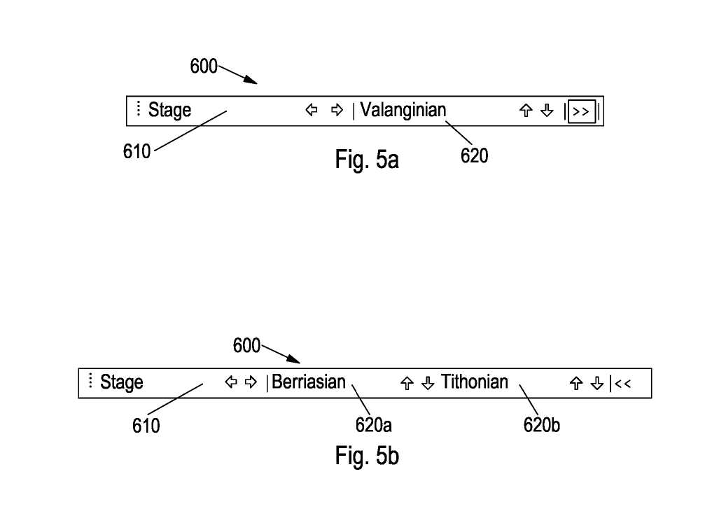

FIG. 5a shows an exemplary interface 600 that the system 100 is configured to present to a user. Here, the interface 600 is configured as a toolbar in a known manner After selection of a particular data type, a user can use the interface 600 to modify the interval so as to provide a different geological event (e.g., age). Here, the interface 600 includes a resolution interface function 610 that permits a user to modify the geological resolution of the interval (e.g., between period 410, epoch 420, or stage 430—stage being currently shown). Further, the interface 600 includes a user-adjustable event function 620, permitting a user to step up and down through the event (e.g., ages), for example within that resolution. As is shown, this is achievable by selecting the up/down arrow at the toolbar. With ease, therefore, a user can “toggle” through modified intervals, and sometimes consecutive intervals, and have these presented that user, without the need to render in 3D space.

In some examples, as shown in FIG. 5b, the user-adjustable age function 620 may include an upper event function 620a, and a lower event function 620b, each of which permit a user to select an upper event of the interval and a lower event of an interval—between which define the geological event/age of the selected interval.

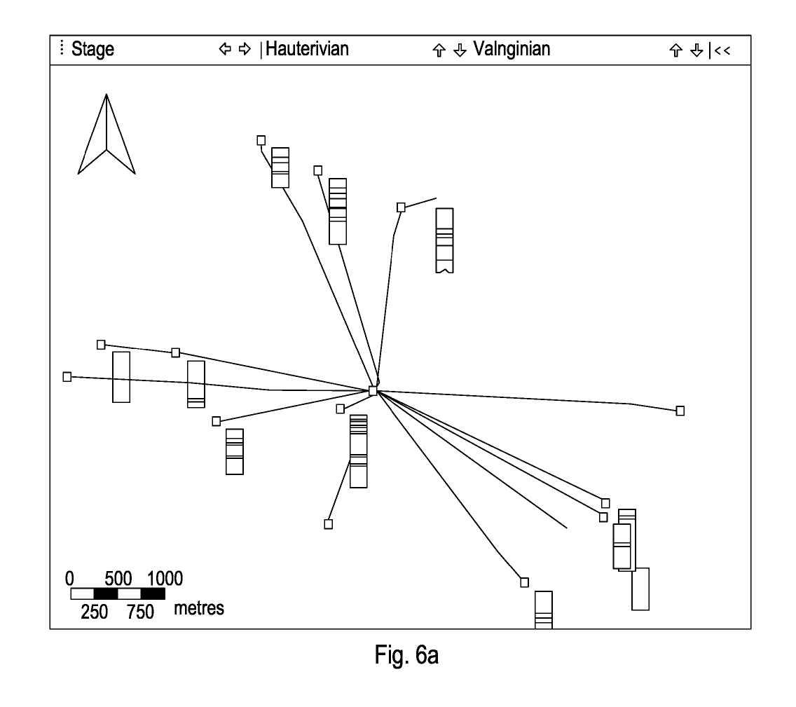

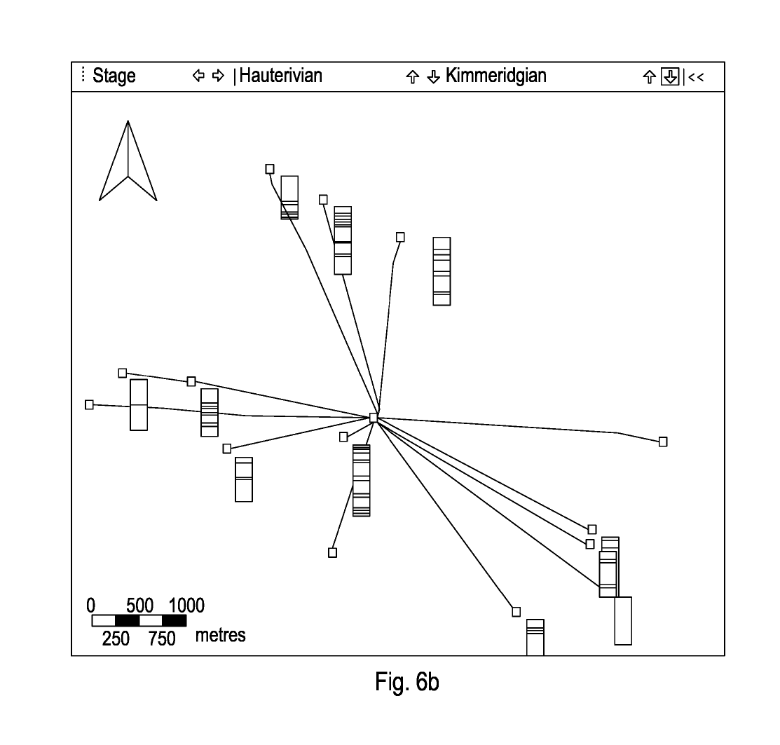

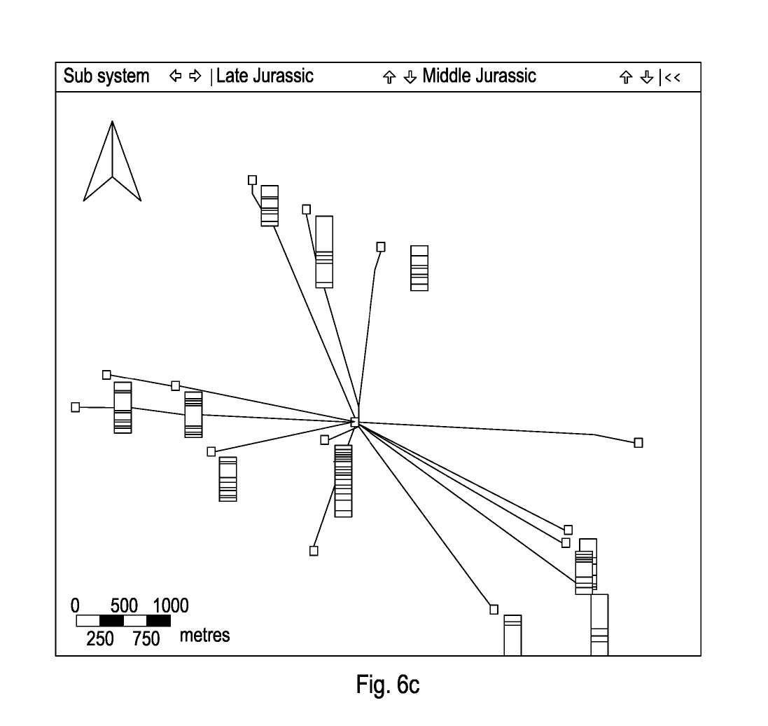

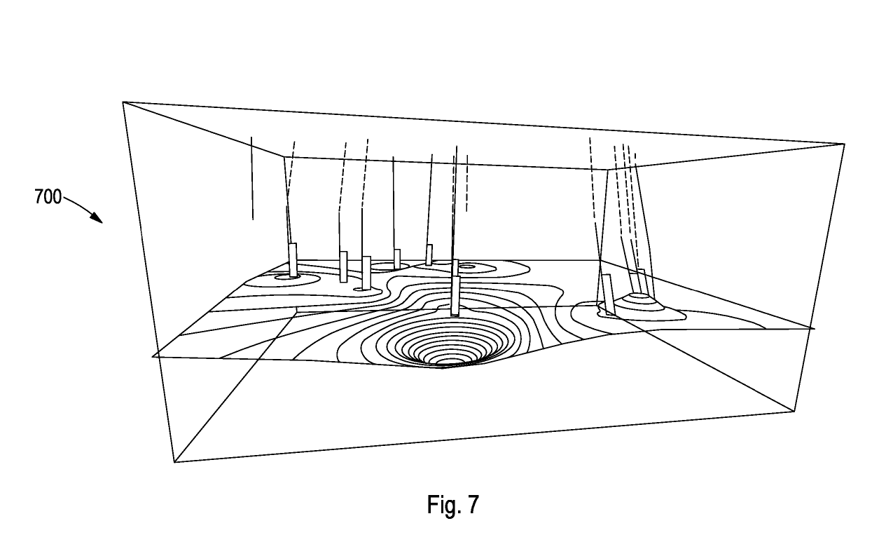

For example—and with reference to FIG. 6—at a first step, a user may select a particular resolution of an interval of interest and observe the region of geological interest at that interval for a particular data type (FIG. 6a). It will be appreciated that in hydrocarbon-bearing formations, the composition of sandstone or the like may be of particular interest—as is shown here in lithographic data. Subsequently, a user may modify the interval and geological event by using the interface 600. For example, a user may step up or step down in events/ages (e.g., one step of the classification scheme 400 at a time) (FIGS. 6b and 6c). In doing so, a user can essentially step up and down with ease through the formation. Upon isolating data of interest, a user may modify the interval so as to change (e.g., increase/decrease) the resolution. Such a process may be considered 2.5D. Subsequently, if desired, a user may then choose to render one or more particular intervals on a 3D virtual map 700 for further analysis—as is shown in FIG. 7.

By associating data in this manner, and permitting a user to select/modify the data in the manner described, a user may be able to assess geological data associated with a region of geological interest 300 quickly and accurately, particularly relating to large volumes of strata data. Such described methods and systems may permit ease of comprehension of data in an efficient manner, and/or may provide the ability to view and browse significantly large data/datasets in an informed way. In either case, this may assist with expedient and accurate assessment of data, thus allowing for critical assessments to be made quickly and easily that may be paramount to the success of exploration projects, or the like. The systems and methods described may be used to optimise processor usage and/or future well development.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the invention may consist of any such individual feature or combination of features. In view of the foregoing description it will be evident to a person skilled in the art that various modifications may be made within the spirit and scope of the invention.

1. A method for processing geological data comprising:
obtaining datasets relating to a plurality of geological zones associated with a region of geological interest;
associating data from the datasets with a plurality of intervals, each interval corresponding to one or more identifiable layers of strata at the geological zones, and each interval being associated with a geological event;
displaying, for each geological zone, a selected data type from each dataset in relation to a particular interval; then
selecting a modified interval having a different geological event; and
displaying, for each geological region, a modified selected data type from each data set based on the modified interval.

2. The method according to claim 1, wherein each interval has a geological age, and wherein the modified interval has a different geological age.

3. The method according to claim 1, wherein the different geological event is consecutive in time with the previous geological event of the unmodified interval.

4. The method according to claim 1, wherein the geological event of the modified interval is contained, wholly or partially, within the previous geological event.

5. The method according to claim 1, wherein the geological zones comprise wellbores, each defined by a zone having a particular depth and direction within the region of geological interest.

6. The method according to claim 1, wherein each dataset comprises a least a first data type comprising data relating to a first type data collection at the zone and a second data type comprising data relating to a second type of data collection the zone.

7. The method according to claim 1, wherein intervals have a particular geological event resolution.

8. The method according to claim 1, comprising displaying the selected data type for a particular interval for each geological zone on a virtual map, the virtual map representing some or all of the region of geological interest.

9. The method according to claim 8, wherein the virtual map is presented to a user at a user interface.

10. The method according to claim 9, wherein the virtual map provides a 2D representation of the region of geological interest.

11. The method according to claim 1, wherein data associated with the selected data type is displayed as icon representations of values or compositions for each geological zone.

12. The method according to claim 11, wherein the data is displayed as bubbles or analytical sticks.

13. The method according to claim 1, wherein, where a dataset relating to a particular geological zone does not contain data relating to the particular interval, then the method comprises displaying inferred data for that particular zone and interval.

14. The method according to claim 13, wherein the inferred data is interpolated from similar data from different intervals associated with that particular zone.

15. The method according to claim 1, comprise selecting, via an icon representation at a user interface, the modified interval and/or selected data type.

16. A method for processing geological data, comprising:
obtaining datasets relating to a plurality of geological zones associated with a region of geological interest;
associating data from the datasets with a plurality of intervals, each interval corresponding to one or more identifiable layers of strata at the geological zones, and each interval being associated with a geological event;
displaying, for some or all geological zones, a selected data type from each dataset in relation to a particular interval; and
in the absence of data of a selected data type for one or more geological zones, then displaying inferred data for that or each zone.

17. A system for processing geological data, the system configured to:
obtain datasets relating to a plurality of geological zones associated with a region of geological interest;
associate data from the datasets with a plurality of intervals, each interval corresponding to one or more identifiable layers of strata at the geological zones, and each interval being associated with a geological event;
display, at a user interface, for each geological zone, a selected data type from each dataset in relation to a particular interval; and then
permit selection of a modified interval having a different geological event, and display, for each geological region, a modified selected data type from each data set based on the modified interval.

18. (canceled)
